(19) United States
(12) Patent Application Publication
(10) Pub. No.: US 2004/0103213 A1
(43) Pub. Date: May 27, 2004

(54) Method of identifying devices using a IPv6 address

(75) Inventor: Soo-Hong Park, Gwangju-gun (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/675,953

(22) Filed: Oct. 2, 2003

(30) Foreign Application Priority Data
Nov. 27, 2002 (KR) 2002-74361

(51) Int. Cl. G06F 15/16

(52) U.S. Cl. 709/245

(57) ABSTRACT

A method of identifying devices using an IPv6 address and a computer readable recording medium on which a data structure formed according to an IPv6 address for identifying devices is recorded, are provided. The method of identifying devices using an IPv6 address comprises identifying the devices using device ID information for identifying the types of devices recorded in an unused area, excluding a bit area used for a particular purpose of a company ID area of an interface ID area, using an EUI-64 ID format.

### BACKGROUND OF THE INVENTION

This application claims the priority of Korean Patent Application No. 2002-74361, filed on Nov. 27, 2002, in the Korean Intellectual Property Office, the disclosure of which is incorporated herein in its entirety by reference.

1. Field of the Invention

The present invention relates to a method of identifying network-connected devices, and more particularly, to a method of identifying devices using an IPv6 address and a computer readable recording medium on which a data structure formed according to an IPv6 address for identifying devices is recorded.

2. Description of the Related Art

Unlike an environment in which personal computers (PCs) or specific related equipment are connected to the Internet, a current Internet environment is rapidly changing into an environment in which all devices are connected to one another. In particular, in the current Internet environment, due to the development of mobile communication technology, users who want to contact desired services while moving are rapidly increasing.

With these changes, the home environment is being changed greatly. Home electronic devices do not only perform their own functions. They now need to be network-connected to one another and to share desired information. Also, they require an environment in which desired functions can be more intelligently performed at any time and any place instead of users requiring a simple function performed by an existing remote control for controlling a TV or an air conditioner. In this respect, various home network technologies in which a TV or an audio device are connected to each other and home electronic devices are connected to one another at home have been developed. In current technologies, there are no difficulties in establishing a communication means solely in the home. However, users require an environment in which they can contact home network devices outside and where home network devices are connected to an external Internet network. In this case, a home network needs to be connected to the Internet via a gateway.

However, for this purpose, several different protocol conversions should be undergone. Even though a protocol conversion is undergone, due to a load concentration or a gateway failure, communication in all devices may be impossible. Also, a unique address is required so that an end-to-end service, which is a feature of the Internet, can be made and by using the unique address, various existing applications can be used and new applications can be developed. For this purpose, a global address is required in devices for communication to take place, and in particular, a number of unique addresses are required in consideration of the number of devices installed in a home.

Meanwhile, a 32-bit IPv4 address is used currently for the Internet. However, due to the thoughtless allocation of addresses and a geometrical progression increase in addresses, the lack of addresses has been a subject of discussion for a long time. In particular, the function of the IPv4 address cannot be supported in an environment where many addresses are required like a home network.

That is, the number of usable addresses of the IPv4 address is 43 hundred million at the most. Thus, like stated above, the IPv4 address cannot be used in an environment which requires many addresses like the home network. Also, in order to solve this problem, when network address translation (NAT) is used, an additional technology for connecting from outside is required, and thus, many limitations exist.

When a user connects to the Internet at home, a variety of settings, including an address, is required. Unlike PCs, most home network devices do not have an environment in which additional addresses can be set, and thus, a function in which home network devices automatically have an address without setting the address is indispensable. Addresses can be dynamically allocated by using a dynamic host configuration protocol (DHCP). However, a DHCP server must be managed, and thus, the DHCP is not appropriate for a home network.

One of the most important factors in the home network is security. When an unsecured user connects to the Internet at home, many problems can occur. Thus, it is very important to authenticate and control a connector.

For these reasons, an IPv6 address has been proposed. The IPv6 address can provide a sufficient number of addresses and put into effect the network connection plug-and-play, and thus, required settings, including unique addresses of devices, are automatically configured. Also, the IPv6 address provides an IP security protocol (IPSEC) about a communication partner's authentication, authentication of the communication contents, and the communication contents themselves.

The structure of an IPv6 address 100 is shown in FIG. 1.

The upper 64-bits of the IPv6 address 100 reflect a network ID 110 and is determined by a prefix corresponding to each network. In general, when a global address is generated, the global address is relayed to a corresponding network by using network equipment (router) such that all users can set addresses automatically. Specifically, a 3-bit format prefix 111 indicates the types of addresses, a 13-bit TLA ID 112 is a prefix area in an uppermost layer, a 8-bit reserved area 113 is a reserved area to be used at a later time, a 24-bit NLA ID 114 is a prefix area in a next layer, and a 16-bit SLA ID 115 is a prefix area in a site layer.

Also, the lower 64-bits reflect an interface ID 120 and are formed using a 48-bit media access control (MAC) address of each device. In this case, a unique 64-bit ID of each device is generated using an extended unique identifier (EUI)-64 ID format.

The upper 64-bit network ID prefix information is combined with the lower 64-bit interface ID such that a unique 128-bit IPv6 address is generated.

Likewise, due to the sufficient number of addresses, an automatic setting function, and a security function of the IPv6 address, various devices that had no relation with a network can be connected to the Internet.

Meanwhile, a media access control (MAC) address is a 48-bit address for identifying each host on a local area network (LAN). The structure of a MAC address 200 is shown in FIG. 2.

The MAC address 200 includes an upper 24-bit company ID 210 and a lower 24-bit serial number 220. The company ID 210 is a value indicating a manufacturer of a device and is allocated by IEEE. Also, the lower 24-bits of the MAC address 200 are a serial number 220 and represents a serial number of a device using the MAC address 200. The 48-bit address is a unique ID of the device.

Currently, an extended unique identifier (EUI)-64 ID format is used in the lower 64-bit interface ID of the IPv6 address. An EUI-64 ID is specified to automatically form an address. When the EUI-64 ID is used to automatically form an address, a global bit of the interface ID (upper seventh bit of the interface ID) should be set. In the EUI-64 ID format, when a 64-bit EUI-64 ID is generated using the 48-bit MAC address of the device, the 64-bit EUI-64 ID is generated by combining a predetermined value 0xFFFE of 16-bit between a lower 24-bit serial number and the upper 24-bit company ID.

An IPv6 address 300 which forms the lower 64-bit interface ID using the EUI-64 format, is shown in FIG. 3. That is, a 64-bit interface ID 120 includes a company ID area 210, an area 230 in which a predetermined value 0xFFFE is recorded, and an area 220 in which serial numbers are recorded.

A MAC address which is a physical address of the device, is used in the IPv6 address using the EUI-64 ID format. A method of identifying the types of devices has not yet proposed in the IPv6 address.

Meanwhile, Korean Patent Publication No. 2002-47635 discloses an apparatus for setting IP addresses for home electronic devices by which IP addresses for the home electronic devices which are connected to an external communication network and can be remotely controlled, are remotely set according to MAC addresses uniquely assigned when devices are manufactured such that the IP addresses can be easily set. However, the apparatus for setting IP addresses for home electronic devices gathers all MAC addresses, checks home electronic devices to which IP addresses are not assigned, and sets new IP addresses for home electronic devices in comparison with the MAC addresses, thereby failing to propose a method of setting unique addresses in home electronic devices using an IPv6 address.

### SUMMARY OF THE INVENTION

The present invention provides a method of identifying devices using an IPv6 address and a computer readable medium on which a data structure formed according to the IPv6 address for identifying devices is recorded.

Accordingly, according to an aspect of the present invention, there is provided a method of identifying devices using an IPv6 address, the method comprising identifying the devices using device ID information for identifying the types of devices recorded in an unused area, excluding a bit area used for a particular purpose of a company ID area of an interface ID area, using an EUI-64 ID format.

According to another aspect of the present invention, there is provided a computer readable recording medium on which a data structure formed according to an IPv6 address for identifying devices is recorded. The data structure includes a network ID area for identifying networks to which the devices are connected and an interface ID area for identifying addresses of the devices on the networks, and the interface ID area includes a company ID area for identifying manufacturers of the devices and a serial number area for identifying unique numbers assigned to the devices, and the company ID area includes a bit area used for a particular purpose and a device ID area for identifying the types of devices, excluding the bit area used for a particular purpose.

### BRIEF DESCRIPTION OF THE DRAWINGS

The above and other aspects and advantages of the present invention will become more apparent by describing in detail preferred embodiments thereof with reference to the attached drawings in which:

FIG. 1 illustrates the structure of a conventional IPv6 address;

FIG. 2 illustrates the structure of a conventional MAC address;

FIG. 3 illustrates the structure of an IPv6 address using a unique identifier (EUI)-64 ID format;

FIG. 4 illustrates an embodiment of the structure of an IPv6 address for identifying devices according to the present invention;

FIG. 5 illustrates device IDs addressed according to a method shown in FIG. 4;

FIG. 6 illustrates several addresses of a DTV addressed using the device ID shown in FIG. 5;

FIG. 7 illustrates several addresses of a refrigerator addressed using the device ID shown in FIG. 5;

FIG. 8 illustrates several addresses of an air conditioner addressed using the device ID shown in FIG. 5; and

FIG. 9 illustrates a home network including devices addressed using the device ID shown in FIG. 5.

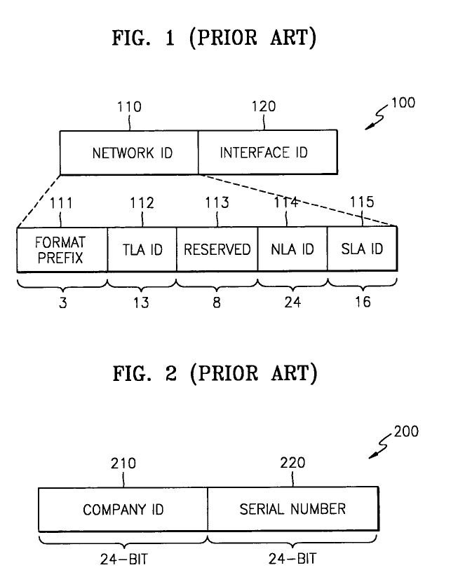

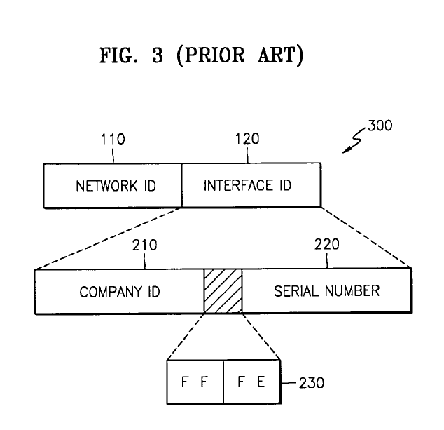

### DETAILED DESCRIPTION OF THE INVENTION

Hereinafter, the present invention will be described in detail with reference to the accompanying drawings.

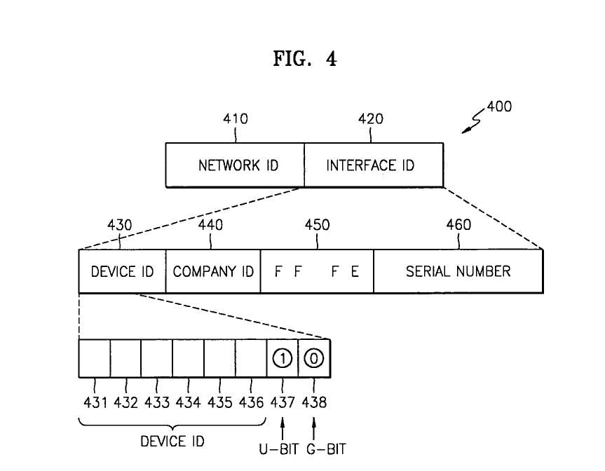

An IPv6 address 400 which forms a lower 64-bit interface ID using a unique identifier (EUI)-64 ID format according to the present invention, is shown in FIG. 4.

As described previously, the IPv6 address 400 includes a network ID area 410 and an interface ID area 420. The interface ID area 420 includes a device ID area 430, a company ID area 440, a predetermined value area 450, and a serial number area 460.

To be more specific, the device ID area 430 is part of the company ID area 440 allocated by IEEE. The basic principle of the present invention is to identify the types of devices using an unused area excluding a used area of the company ID area 440. That is, an area to be used as a device ID is an area excluding a used area for indicating a real company ID and an area used for a particular purpose of the company ID area 440. The area used for a particular purpose includes a U-bit area and a G-bit area, for example, as described above.

If a value for identifying the types of devices is set using the unused area of an interface ID area, all devices may have their own unique IDs without setting additional names or addresses.

For example, as shown in FIG. 4, a device ID can be set using an upper 1-byte (431-438) of the interface ID area 420. Actually, the upper seventh bit 437 is a U-bit for setting a universal bit, and the upper eighth bit 438 is a G-bit for setting an individual/group bit. A desired value can be set using a bit area excluding the above two mentioned types of bits.

Thus, a device ID may be set using top 6 bits (431, 432, 433, 434, 435, and 436).

Meanwhile, if devices connected to one home network have a plurality of identical device IDs, that is, if several DTVs are connected to one home network, these DTVs may be further identified by their serial numbers.

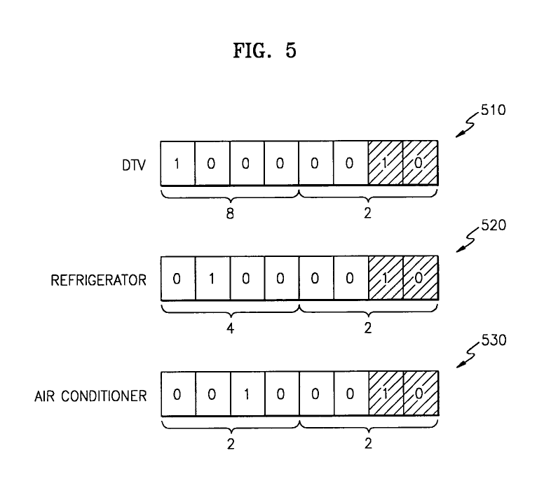

An example in which a device ID address generated in the above-mentioned manner is shown in FIG. 5.

For example, in the case of a DTV, an uppermost bit of a device ID area may be set to ‘1’. If so, the upper 4 bits of the device ID area become “1000” and 8 when expressed as a hexadecimal. If a third U-bit is set, the lower 4 bits of the device ID area become “0010” and 2 when expressed as a hexadecimal, and thus the device ID area becomes “82” (510).

In the case of a refrigerator, a second bit of the device ID area may be set to “1”. If so, the upper 4 bits of the device ID area become “0100” and 4 when expressed as a hexadecimal, and the lower 4 bits of the device ID area become “0010” and 2 when expressed as a hexadecimal and thus the device ID area can become “42” (520).

In the case of an air conditioner, a third bit of the device ID area may be set to “1”. If so, the upper 4 bits of the device ID area become “0010” and 2 when expressed as a hexadecimal, and the lower 4 bits of the device ID area become “0010” and 2 when expressed as a hexadecimal and thus the device ID area can become “22” (530).

As in an IPv4 address, one IPv6 address is not allocated to one device, but several addresses can be allocated to one device depending on an area. Among these addresses, only a unicast address will be described below.

A link local unicast address is used only in its link and starts from FE80 (hexadecimal). By using the link local unicast address, a device may be automatically constructed without additional settings.

A site local unicast address is used only in its particular site and starts from FECO (hexadecimal). The site local unicast address can be set in a particular site and cannot pass through a router. When a global prefix is not allocated to a device, the site local unicast address can be used in a particular site using the global prefix.

A global unicast address is used in a real Internet network and starts from 2001 (hexadecimal).

Among these unicast addresses, the link local unicast address may be addressed without an additional prefix, and the site local unicast address and the global unicast address may be addressed only when corresponding prefix information is received.

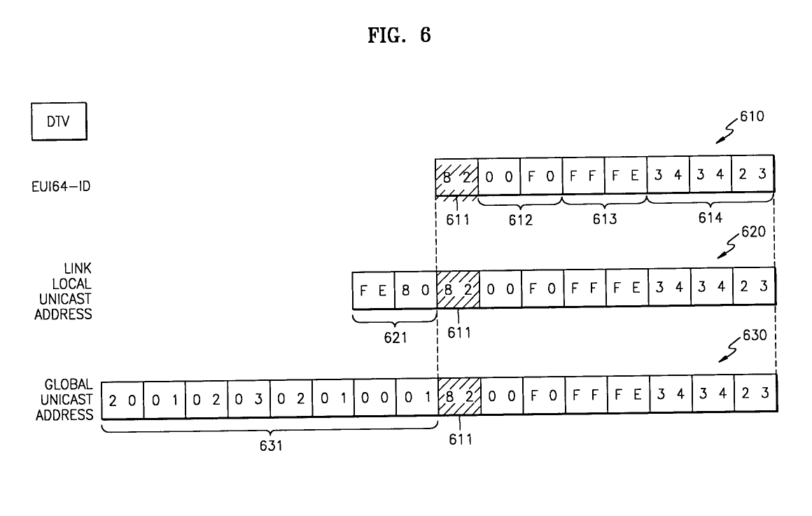

An EUI-64 ID, a link local unicast address, and a global unicast address for addressed devices (i.e, DTV, refrigerator, air conditioner) shown in FIG. 5, according to the present invention, are shown in FIGS. 6 through 8.

Referring to FIG. 6, an EUI-64 ID address 610 for a DTV includes a device ID area 611 addressed as “82”, a company ID area 612 addressed as “OOFO”, a predetermined value area 613, and a serial number area 614 addressed as “343423”. The EUI-64 ID address 610 for a DTV becomes “8200:F0FF:FE34:3423” when expressed as a hexadecimal, and a link local unicast address 620 becomes “FE80:8200:F0FF:FE34:3423” by adding “FE80” (621) before the EUI-64 ID address 610. Also, a global unicast address 630 becomes “2001:0230:0201:0001:8200:F0FF:FE34:3423” by adding “2001:0203:0201:0001” (631) before the EUI-64 ID address 610.

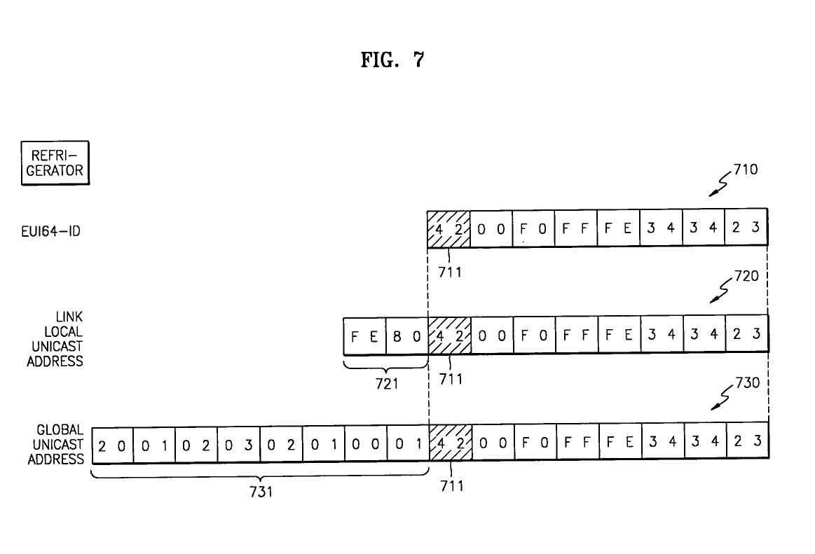

Referring to FIG. 7, an EUI-64 ID address 710 for a refrigerator becomes “4200:F0FF:FE34:3423” when expressed as a hexadecimal, and a link local unicast address 720 becomes “FE80:4200:F0FF:FE34:3423” by adding “FE80” (721) before the EUI-64 ID address 710. A global unicast address 730 becomes “2001:0203:0201:0001:4200:F0FF:FE34:3423” by adding “2001:0203:0201:0001” (731) before the EUI-64 ID address 710.

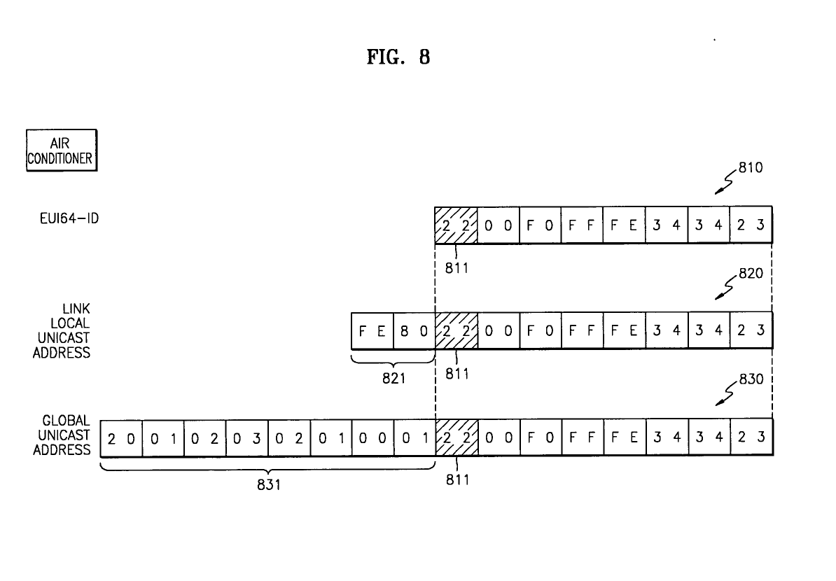

Referring to FIG. 8, an EUI-64 ID address 810 for an air conditioner becomes “2200:F0FF:FE34:3423” when expressed as a hexadecimal, and a link local unicast address 820 becomes “FE80:2200:F0FF:FE34:3423” by adding “FE80” (821) before the EUI-64 ID address 810. Also, a global unicast address 830 becomes “2001:0203:0201:0001:2200:F0FF:FE34:3423” by adding “2001:0203:0201:0001” (831) before the EUI-64 ID address 810.

Each of the devices connected to a home network has a unique address using a value from a unique ID set according to each of the devices. If global prefix information is relayed to the home network, all of the devices have link local unicast addresses and global unicast addresses. If the link local unicast addresses are used, the devices automatically have one address. The link local unicast addresses can be used only in the home network, and for external connection, all of the devices should have global unicast addresses.

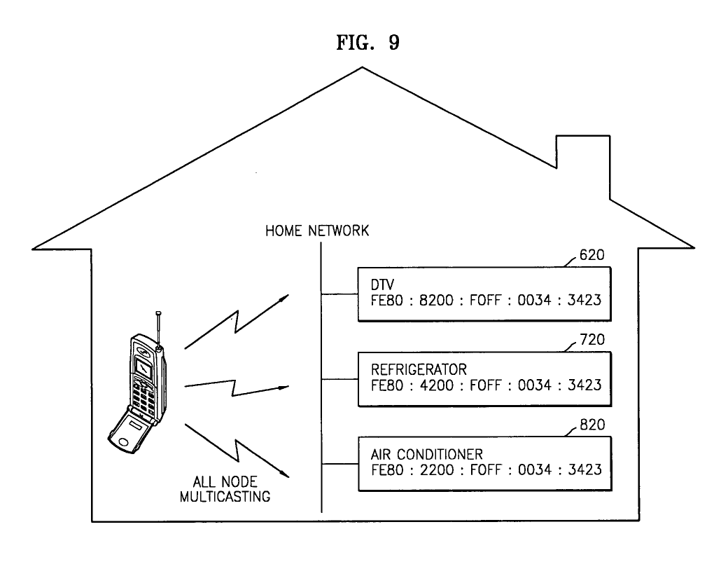

A home network including devices addressed using the device ID shown in FIG. 5, is shown in FIG. 9. In this case, a user should have addresses of devices existing in the home network through multicasting so as to connect devices having an address system according to the present invention. Currently, the IPv6 address provides an all node multicast address FF01::1, and thus may be used.

For example, a device requests addresses of devices connected to a home network using an all node multicast. If so, all of home network-connected devices which receive such a request, respond to their addresses, i.e., addresses in which device IDs according to the present invention are set (these addresses may be included in devices from when devices are manufactured).

If so, the device, which receives addresses of the home network-connected devices, identifies desired devices from the received addresses. Of course, if there are a plurality of devices having an identical device ID, the plurality of devices are sequentially aligned using the lower 24-bits of the interface ID area, i.e., serial numbers, such that the device can identify desired devices.

A data structure of an address system using the IPv6 address according to the present invention can also be embodied on computer readable recording media. The computer readable recording media include all types of recording devices in which data that can be read by a computer system are stored, such as ROMs, RAMs, CD-ROMs, magnetic tapes, floppy discs, optical data storage units, and carrier waves (for example, transmission via the Internet). Also, the computer readable recording media are distributed over a network-connected computer system and can be stored and executed by computer readable codes.

As described above, according to the present invention, home network-connected devices can be identified using an IPv6 address without setting additional addresses.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. A method of identifying devices using an IPv6 address, the method comprising identifying the devices using device ID information for identifying the types of devices recorded in an unused area, excluding a bit area used as a company ID area of an interface ID area, using an EUI-64 ID format.

2. The method of claim 1, further comprising identifying the devices using unique numbers assigned to the devices recorded in a serial number area, as well as the device ID information.

3. The method of claim 1, wherein the bit area comprises a U-bit area and a G-bit area.

4. The method of claim 1, wherein the company ID area identifies manufacturers of the devices.

5. A computer readable recording medium on which a data structure formed according to an IPv6 address for identifying devices is recorded, wherein the data structure includes a network ID area for identifying networks to which the devices are connected and an interface ID area for identifying addresses of the devices on the networks, where the interface ID area comprises a company ID area for identifying manufacturers of the devices and a serial number area for identifying unique numbers assigned to the devices, and where the interface ID area comprises a bit area and a device ID area for identifying types of devices, excluding the bit area.

6. The medium of claim 5, wherein the bit area comprises a U-bit area and a G-bit area.
